(19) United States
(12) Patent Application Publication
(10) Pub. No.: US 2022/0247887 A1
(43) Pub. Date: Aug. 4, 2022

(54) CONTROLLED SHARING OF CONTENT DURING A COLLABORATION SESSION

(71) Applicant: Avaya Management L.P., Durham, NC (US)

(72) Inventors: Arjun Sharma, Pune (IN); Mahendra Rochwani, Pune (IN); Narendran Thirunavukkarasu, Pune (IN)

(21) Appl. No.: 17/167,841

(22) Filed: Feb. 4, 2021

(51) Int. Cl. H04N 1/44; H04L 29/06; G06F 3/0484

(52) U.S. Cl. CPC H04N 1/448; G06F 3/04845; H04L 65/4015

(57) ABSTRACT

Collaboration methods and systems are provided. An illustrative collaboration method includes receiving an input indicating a desire to share image content among participants of a collaborative communication session; identifying a first portion of the image content that will have blurring applied thereto when shared among the participants of the collaborative communication session; identifying a second portion of the image content that will not have blurring applied thereto when shared among the participants of the collaborative communication session; and sharing the image content with the participants of the collaborative communication session such that the first portion of the image content is blurred and the second portion of the image content is unblurred.

### FIELD

The present disclosure is generally directed to multi-party communications and, in particular, toward sharing content during a collaboration session.

### BACKGROUND

Conferencing, and in particular web-conferencing or web-collaborations, includes a range of communication services. These communication services can include, meetings, seminars, educational broadcasts, collaborative communication sessions, and/or other communications that are established between communication devices across a network. Information shared during typical collaboration sessions may include video, audio, multimedia, presentations, or other digital content.

A user in a collaboration session may want to share some portion of their screen with other participants. Sometimes the user may want to share their entire screen whereas other times the user may want to share a view of a particular application. There are competing concerns when sharing content. On the one hand, the user wants to show other participants some information from their device, but on the other hand the user may not want to accidentally share too much information (e.g., sensitive information). There may also be cases where the user desires to highlight certain portions of the information they are displaying for other participants.

### BRIEF SUMMARY

The present disclosure aims to solve the above-noted shortcomings associated with collaboration tools and services. In particular, embodiments of the present disclosure contemplate providing collaboration tools that allow a user to share content from their screen with other participants in a secure and controlled manner. Embodiments of the present disclosure also contemplate solutions that allow a user to move through a document point by point or bullet by bulled without requiring zoom in/zoom outs, which adjust a rendering of the shared content for other participants. Embodiments of the present disclosure also contemplate enabling the user to share content in a manner that easily allows the user to highlight or adjust areas of focus without accidentally disclosing sensitive information.

As a non-limiting example, when a user starts sharing content of their screen, s/he can be presented with an option of sharing in blurred mode. When the sharing starts, the shared application or screen will appear in blur which can also be user controlled (e.g., low blurred, medium blurred, high blurred, etc.). The presenting user can then employ an in-collaboration control tool to adjust a size/shape/area of the blurred and/or unblurred content that will be shared with other participants. The presenting user can also adjust an amount of blurring applied to the blurred content. As can be appreciated, the in-collaboration control tool may enable the presenting user to unblur specific portion(s) of the screen that the user wants to share. As an example, the presenting user may initially elect to share an entire application, then move to different portions of the application without necessarily requiring a zoom in or zoom out action. The contrast of blurred and unblurred content will enable the presenting user to hide possibly sensitive information and/or highlight certain portions of shared content.

As another example, embodiments of the present disclosure contemplate a collaboration method that includes: receiving an input indicating a desire to share image content among participants of a collaborative communication session; identifying a first portion of the image content that will have blurring applied thereto when shared among the participants of the collaborative communication session; identifying a second portion of the image content that will not have blurring applied thereto when shared among the participants of the collaborative communication session; and sharing the image content with the participants of the collaborative communication session such that the first portion of the image content is blurred and the second portion of the image content is unblurred.

As another example, embodiments of the present disclosure contemplate a communication system that includes a server, comprising: a microprocessor and a computer readable medium coupled to the microprocessor and including instructions stored thereon that cause the microprocessor to: receive an input indicating a desire to share image content among participants of a collaborative communication session; receive an input indicating a desire to share the image content using a blurred sharing mode; identify a first portion of the image content that will have blurring applied thereto when shared among the participants of the collaborative communication session; identify a second portion of the image content that will not have blurring applied thereto when shared among the participants of the collaborative communication session; and cause the image content to be shared among the participants of the collaborative communication session such that the first portion of the image content is blurred and the second portion of the image content is unblurred.

As another example, embodiments of the present disclosure contemplate a server that includes: a processor and a computer-readable medium, coupled with the processor, the computer-readable medium including instructions that are executable by the processor. The instructions may include instructions that enable a first participant to engage in a collaborative communication session with a second participant; instructions that provide the first participant with an ability to share image content with the second participant using a blurred sharing mode; and instructions that share at least some of the image content with the second participant based on a blurring preference defined by the first participant.

Additional features and advantages are described herein and will be apparent from the following Description and the figures.

### BRIEF DESCRIPTION OF THE DRAWINGS

FIG. 1 depicts a block diagram of a communication system in accordance with at least some embodiments of the present disclosure;

FIG. 2 is a block diagram depicting components of a server used in a communication system in accordance with at least some embodiments of the present disclosure;

FIG. 3 is a block diagram depicting a collaborative communication system user interface in accordance with at least some embodiments of the present disclosure;

FIG. 4A illustrates a first instance of a presenting user's device interface in accordance with at least some embodiments of the present disclosure;

FIG. 4B illustrates a second instance of a presenting user's device interface in accordance with at least some embodiments of the present disclosure;

FIG. 4C illustrates a third instance of a presenting user's device interface in accordance with at least some embodiments of the present disclosure;

FIG. 4D illustrates a fourth instance of a presenting user's device interface in accordance with at least some embodiments of the present disclosure;

FIG. 4E illustrates a fifth instance of a presenting user's device interface in accordance with at least some embodiments of the present disclosure;

FIG. 4F illustrates a sixth instance of a presenting user's device interface in accordance with at least some embodiments of the present disclosure;

FIG. 4G illustrates a seventh instance of a presenting user's device interface in accordance with at least some embodiments of the present disclosure;

FIG. 4H illustrates an eighth instance of a presenting user's device interface in accordance with at least some embodiments of the present disclosure;

FIG. 5 is a flow diagram depicting a first collaboration method in accordance with at least some embodiments of the present disclosure;

FIG. 6 is a flow diagram depicting a second collaboration method in accordance with at least some embodiments of the present disclosure; and

FIG. 7 is a flow diagram depicting a third collaboration method in accordance with at least some embodiments of the present disclosure.

### DETAILED DESCRIPTION

Embodiments of the present disclosure will be described in connection with the execution of a communication system. The communication system may be configured to manage communications between one or more communication devices. In some cases, the system may establish collaborative communication sessions, multi-party meetings, presentations, or conferences, between multiple communication devices across a communication network. The collaborative communication session may include presentations and one or more of a presenter, a moderator, a participant, or presentation content.

When a presenting user is sharing content in a collaborative communication session, the presenting user may be allowed to control the manner in which content from their device is displayed to other participants in the collaborative communication session. In some embodiments, the presenting user may be allowed to share content from their device using a blurred sharing mode. In the blurred sharing mode, the presenting user may be allowed to control which portion(s) of their user interface they desire to share with other participants. The portion(s) identified as subject to sharing may be shared without blurring while other portions not subject to sharing may be blurred and shared. The presenting user may also be allowed to move and/or adjust the location/size/shape of the shared portions, resulting in a change of focus. Furthermore, the presenting user can adjust the amount of blurring applied to the blurred portions to help hide potentially sensitive information.

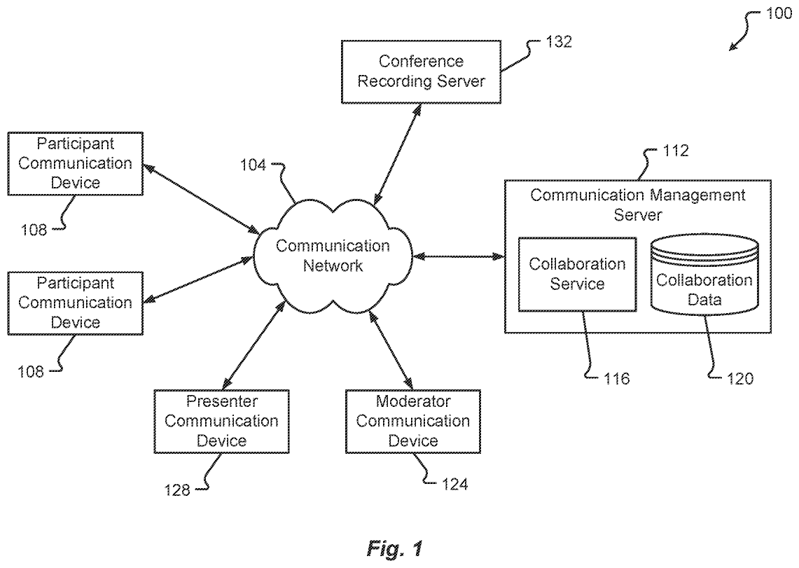

Referring to FIG. 1, a block diagram of a communication system 100 is shown in accordance with at least some embodiments of the present disclosure. The communication system 100 of FIG. 1 may be a distributed system and, in some embodiments, comprises a communication network 104 connecting communication devices 108, 124, 128 with a communication management server 112. The communication management server 112 will be described as an entity that facilitates the establishment and management of a collaboration communication session between users of the communication devices 108, 124, 128. Although depicted as a separate entity executed on a server, it should be appreciated that components of the communication management server 112 depicted and described herein can be provided on a communication device 108, 124, and/or 128, meaning that certain aspects of collaboration session management and/or control may be executed at a communication device rather than at the communication management server 112. The communication management server 112 is illustrated as a stand-alone entity for ease of discussion and understanding.

The communication management server 112 may include a collaboration service 116 and collaboration data 120. In one embodiment, communication devices 108, 124, 128 may be communicatively connected to a collaboration service 116 of the communication management server 112. For example, the collaboration service 116 may provide collaborative communication sessions, multi-party calls, web-based conferencing, web-based seminar (“webinar”), and/or other audio/video communication services. In any event, the collaborative communication sessions can include two, three, four, or more communication devices 108, 124, 128 that access the collaboration service 116 via the communication network 104.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over Internet Protocol (VoIP) network, a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. The communication network 104 may comprise a number of different communication media such as coaxial cable, copper cable/wire, fiber-optic cable, antennas for transmitting/receiving wireless messages, and combinations thereof.

The communication devices 108, 124, 128 may correspond to at least one of a smart phone, tablet, personal computer, and/or some other computing device. Each communication device 108, 124, 128 may be configured with an operating system (“OS”) and at least one communication application. The communication application may be configured to exchange communications between the communication device 108, 124, 128 and another entity (e.g., a communication management server 112, another communication device 108, 124, 128, etc.) across the communication network 104. Additionally or alternatively, communications may be sent and/or received via the communication device 108, 124, 128 as a telephone call, a packet or collection of packets (e.g., IP packets transmitted over an IP network), an email message, an instant message (“IM”), an SMS message, an MMS message, a chat, and/or combinations thereof. In some embodiments, the communication device 108, 124, 128 may be associated with one or more users in the communication system 100. In one embodiment, a communication device 108, 124, 128 may switch from a participant device to a presenting device or a moderator device, and vice versa.

The communication management server 112 may include hardware and/or software resources that, among other things, provides the ability to hold multi-party calls, conference calls, and/or other collaborative communications. The communication management server 112 may include a conference service 112, conference data memory 120, a tag application module 124, and conference and tag information memory 128 to name a few.

In some embodiments, the collaboration service 116 may be included in the communication management server 112 and/or as a separate service or system of components apart from the communication management server 112 in the communication system 100. Illustratively, but without limitation, some or all of the collaboration server 116 may be provided in a communication device 108, 124, 128. In any event, the collaboration service 116 provides conferencing resources that can allow two or more communication devices 108 to participate in a collaborative communication session or conference. One example of a collaborative communication session includes, but is not limited to, a web-conference session between two or more users/parties, webinars, collaborative meetings, and the like. Although some embodiments of the present disclosure are discussed in connection with collaborative communication sessions, embodiments of the present disclosure are not so limited. Specifically, the embodiments disclosed herein may be applied to one or more of audio, video, multimedia, conference calls, web-conferences, and the like.

In some embodiments, the collaboration service 116 can include one or more resources such as conference mixers and other conferencing infrastructure. As can be appreciated, the resources of the collaboration service 116 may depend on the type of collaborative communication session provided by the collaboration service 116. Among other things, the collaboration service 116 may be configured to provide conferencing of at least one media type between any number of participants. The conference mixer of the collaboration service 116 may be assigned to a particular collaborative communication session for a predetermined amount of time. In one embodiment, the conference mixer may be configured to negotiate codecs with each communication device 108, 124, 128 participating in a collaborative communication session. Additionally or alternatively, the conference mixer may be configured to receive inputs (at least including audio inputs) from each participating communication device 108, 124, 128 and mix the received inputs into a combined signal which can be monitored and/or analyzed by the communication management server 112.

The collaboration data memory 120 may include presentations, slides, documents, participant information, uploaded information, participant information, invitation information, applications, and/or other information accessed by the collaboration service 116 and/or the communication management server 112. For instance, a meeting host may upload a presentation and/or other digital files to the collaboration data memory 120 of the server 116 prior to, or during, a meeting.

The communication system 100 is also shown to include a conference recording server 132. The conference recording server 132 may provide functionality that enables content of a collaborative communication session to be recorded and stored for later access. As an example, the conference recording server 132 may be configured to store recorded content of a collaborative communication session, which may include audio, video, and/or shared screen content. Although depicted as being separate from the communication management server 112, it should be appreciated that the functionality of the conference recording server 132 may be provided in the communication management server 112, perhaps by the collaboration service 116 or separate from the collaboration service 116.

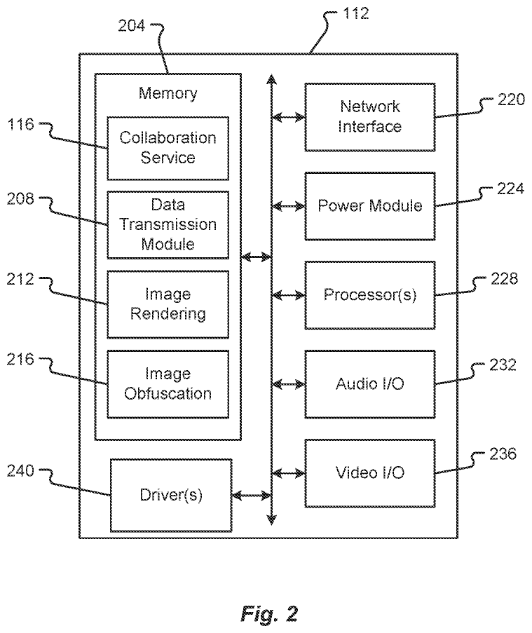

FIG. 2 is a block diagram depicting details of a communication management server 112 used in the communication system 100 in accordance with at least some embodiments of the present disclosure. The server 112 is shown to include a computer memory 204 that stores one or more instruction sets, applications, or modules, potentially in the form of a collaboration service 116, a data transmission instruction set 208, an image rendering instruction set 212, and/or an image obfuscation instruction set 216. The communication management server 112 may be configured as a server, or part of a server, that includes any or all of the components of the communication system 100 depicted in FIG. 1. The communication management server 112 is also shown to include a network interface 220, a power module 224, a processor 228, an audio input/output (“I/O”) 232, a video I/O 236, and one or more drivers 240.

The memory 204 may correspond to any type of non-transitory computer-readable medium. In some embodiments, the memory 204 may comprise volatile or non-volatile memory and a controller for the same. Non-limiting examples of memory 204 that may be utilized in the communication management server 132 include RAM, ROM, buffer memory, flash memory, solid-state memory, or variants thereof. Any of these memory types may be considered non-transitory computer memory devices even though the data stored thereby can be changed one or more times.

The applications/instructions 116, 208, 212, 216 may correspond to any type of computer-readable instructions or files storable in the memory 204. The data transmission module 208 may receive presentation information from a presenter communication device 128 representing data (e.g., presentation content, digital media, slides, etc.) to be shared with one or more participant, or communication, devices 108 in the communication system 100. Upon receiving the presentation information (e.g., from a presenter communication device 128, etc.), the data transmission module 208 may convert the presentation data into one or more “frames.” Each frame may represent content from a stream of images in the presentation. The images may be encoded in a particular format (e.g., JPEG, PNG, etc.), and when converted into frames, are sent across the communication network 104 via a reliable transfer protocol. For instance, a frame representing a particular slide may be sent across the communication network using the TCP/IP protocol. Continuing this example, the data transmission module 208 may send a frame to a receiving device (e.g., communication devices 108, 124, 128, etc.) requiring a positive acknowledgment by the receiving device (e.g., an ACK signal, etc.). If the acknowledgment signal is not received by the data transmission module 208, the data transmission module 208 may retransmit the frame until the acknowledgment signal is received. When the acknowledgment signal is received, the data transmission module 208 may proceed by transmitting a new frame (e.g., the subsequent frame, etc.) in the presentation to the receiving device. It is an aspect of the present disclosure that the data transmission module 208 may track (e.g., determine and store, etc.) the last successfully transmitted frame (e.g., where an ACK signal was received, etc.) for each communication device 108, 124, 128 participating in the collaborative communication system.

The image rendering instructions 212 may be configured to generate/render an image based on information associated with a particular device 108, 124, 128 that is, or was, part of a collaborative communication session. The image may correspond to a video clip, a thumbnail, an icon, a representative image, or other image or group of images. The image may be associated with the frame that was last successfully transmitted to (and received by) the particular device 108, 124, 128. As can be appreciated, the image rendering instructions 212 may communicate with the collaboration service 116, the data transmission module 208, and/or any data associated with one or more communication devices 108, 124, 128, transmitted frames, presentation information, and/or the like.

The image obfuscation instructions 216 may be configured to operate in cooperation with the image rendering instructions 212. As an example, the image rendering instructions 212 may be responsible for enabling a presenting user to share content displayed on their communication device (e.g., on a user interface of a presenter communication device 128). The content may be shared in a normal fashion (e.g., the presenting user may elect to share all of their screen or selected portions of their screen, which may correspond to a predetermined or selected application window). Alternatively or additionally, the presenting user may desire to share the content displayed on their communication device in a blurred mode. In this situation, the image rendering instructions 212 may call the image obfuscation instructions 216 to provide the presenting user with a collaboration tool that allows the presenting user to select certain portions of their screen to blur and other portions of their screen to not blur. The presenting user may interact with the collaboration tool to select which portion(s) (e.g., one or multiple portions) of their screen should be shared in an unblurred state whereas other portions(s) may be shared in a blurred state, thereby obfuscating the blurred portions from clear view by receiving users. It should be appreciated that functionality of the image obfuscation instructions 216 may be contained natively within the image rendering instructions 212.

The driver(s) 240 may correspond to hardware, software, and/or controllers that provide specific instructions to hardware components of the communication management server 112, thereby facilitating their operation. For instance, the network interface 220, power module 224, audio I/O 232, video I/O 236, and/or memory 204 may each have a dedicated driver 240 that provides appropriate control signals to effect their operation. The driver(s) 240 may also comprise the software or logic circuits that ensure the various hardware components are controlled appropriately and in accordance with desired protocols. For instance, the driver 240 of the network interface 220 may be adapted to ensure that the network interface 220 follows the appropriate network communication protocols (e.g., TCP/IP (at one or more layers in the OSI model), TCP, UDP, RTP, GSM, LTE, Wi-Fi, etc.) such that the network interface 220 can exchange communications via the communication network 104. As can be appreciated, the driver(s) 240 may also be configured to control wired hardware components (e.g., a USB driver, an Ethernet driver, fiber optic communications, etc.).

The network interface 220 may comprise hardware that facilitates communications with other communication devices over the communication network 104. As mentioned above, the network interface 220 may include an Ethernet port, a Wi-Fi card, a Network Interface Card (NIC), a cellular interface (e.g., antenna, filters, and associated circuitry), or the like. The network interface 220 may be configured to facilitate a connection between the communication management server 112 and the communication network 104 and may further be configured to encode and decode communications (e.g., packets) according to a protocol utilized by the communication network 104.

The power module 224 may include a built-in power supply (e.g., battery) and/or a power converter that facilitates the conversion of externally-supplied AC power into DC power that is used to power the various components of the communication management server 112. In some embodiments, the power module 224 may also include some implementation of surge protection circuitry to protect the components of the communication management server 112, or other associated server, from power surges.

The processor 228 may correspond to one or many microprocessors that are contained within a common housing, circuit board, or blade with the memory 204. The processor 228 may be a multipurpose, programmable device that accepts digital data as input, processes the digital data according to instructions stored in its internal memory, and provides results as output. The processor 228 may implement sequential digital logic as it has internal memory. As with most microprocessors, the processor 228 may operate on numbers and symbols represented in the binary numeral system.

The audio I/O interface 232 can be included to receive and transmit audio information signals between the various components of the system 100. By way of example, the audio I/O interface 232 may comprise one or more of an associated amplifier and analog to digital converter. Alternatively or additionally, the audio I/O interface 232 may be configured to separate audio information from a media stream provided to, or received by, the communication management server 112. This information may be separated in real-time, or as the information is received by the communication management server 112.

The video I/O interface 236 can be included to receive and transmit video signals between the various components in the system 100. Optionally, the video I/O interface 236 can operate with compressed and uncompressed video signals. The video I/O interface 236 can support high data rates associated with image capture devices. Additionally or alternatively, the video I/O interface 236 may convert analog video signals to digital signals. Similar to the audio I/O interface 232, the video I/O interface 236 may be configured to separate video information from a media stream provided to, or received by, the communication management server 112.

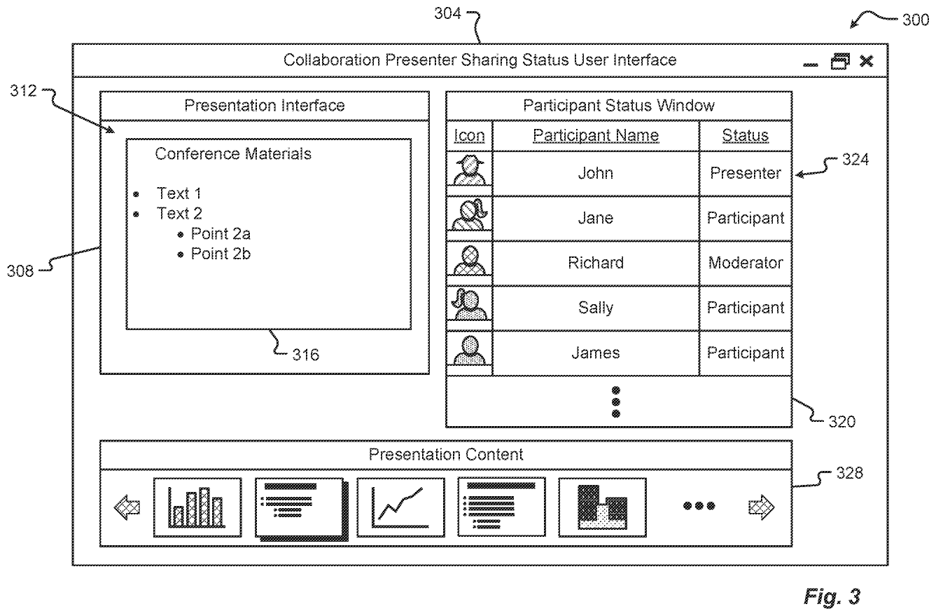

FIG. 3 illustrates a collaborative communication system user interface 300 in accordance with at least some embodiments of the present disclosure. The user interface 300 may include a window 304 that can be presented to a display of a communication device 108, 124, 128 or server 112. It should be appreciated that the user interface 300 presented to one user (e.g., via a participant communication device 108) may be different from the user interface 300 presented to another user (e.g., via a presenter communication device 128 and/or moderator communication device 124).

The window 304 may include identification information, application controls, and at least one viewing area. The viewing area of the window 304 may be separated into a number of different areas 308, 320, 328. In particular, the window 304 may include a presentation interface area 308, a participant device status viewing area 320, and a presentation content viewing area 328.

The presentation interface area 308 may include a display area 312. The display area 312 may be configured to present information pertinent to the collaborative communication session, participants, files, documents, etc. The display area 312 may show recorded, live, or other presentations, slides, images, and/or video streams. As shown in FIG. 3, the display area 312 includes an image of a displayed presentation slide 316 (e.g., electronic presentation image, slide, digital image, application window, etc.). In some embodiments, the display area 312 may show a presentation or other display content shared between one or more participants in a collaborative communication session or meeting. In one embodiment, a display of the particular information shown in the display area 312 may be selectively controlled by a presenter (e.g., via a presenter communication device 128, etc.), a participant (e.g., via a communication device 108, etc.), and/or a moderator (e.g., via a moderator communication device 124, etc.) in the collaborative communication session. In the case of certain presentations and/or conferences (e.g., interactive communications, webinars, buffered presentations, etc.), the presentation interface area 308 may include playback controls, audio controls, video controls, and/or other content controls.

The participant device status viewing area, or interface 320 may provide a user interface to at least one of view, order, rank, and/or expand details corresponding to participants communicatively connected to the collaborative communication session via one or more communication devices 108. In some embodiments, the participant device status viewing area 320 may dynamically and continually update a presentation viewing status associated with a particular participant's communication device 108, 124, 128.

As illustrated in FIG. 3, the participant device status viewing area 320 is shown including a number of rows 324. Each row 324 may correspond to a particular participant and/or participant device 108, 124, 128 that is communicatively connected to the communication management server 112. For instance, the first row 324 shows (from left to right) a user icon (e.g., symbol, video image, photograph, live video feed, and/or avatar, etc. associated with a first participant), an identification (e.g., participant name, title, etc.) of the first participant, and a presentation status indicator. Although shown as text, the status indicator may take a number of forms. For example, the status indicator may be represented as text, images, moving images, video, lights, colors, etc., and/or combinations thereof. It should be appreciated that the participant device status viewing area 320 or the rows 324 may include more or less information than is shown in FIG. 3.

The presentation content viewing area 328 may include a display area configured to present information pertinent to the presentation, files, documents, and/or other information shared during the collaborative communication session. In one embodiment, the presentation content viewing area 328 may include information associated with a presentation as the information is being presented (e.g., to the display area 312, etc.). As shown in FIG. 3, the presenting user may navigate through a number of slides represented as thumbnails in a presentation. The individual slides and thumbnails may be manually selected by the presenting user. When a particular slide 316 is displayed to the display area 312, the slide thumbnail representing that slide may be highlighted in the presentation content viewing area 328. In one embodiment, when a particular slide thumbnail is selected, the corresponding slide will be displayed in the display area 312. In any event, a particular slide thumbnail may be highlighted, or otherwise identified, as being displayed to the display area 312 (e.g., as presentation slide 316). As shown in FIG. 3, this identification is shown by a dark shading, or shadow, behind the thumbnail image of slide thumbnail.

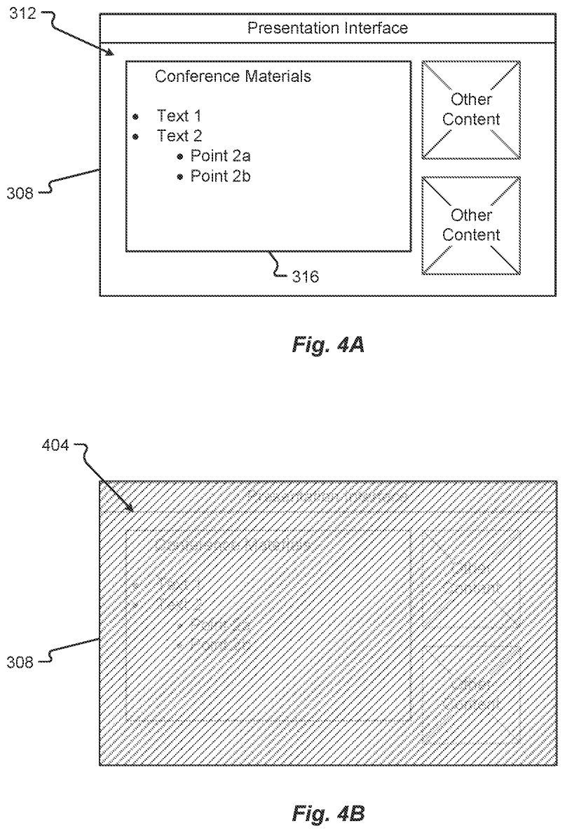

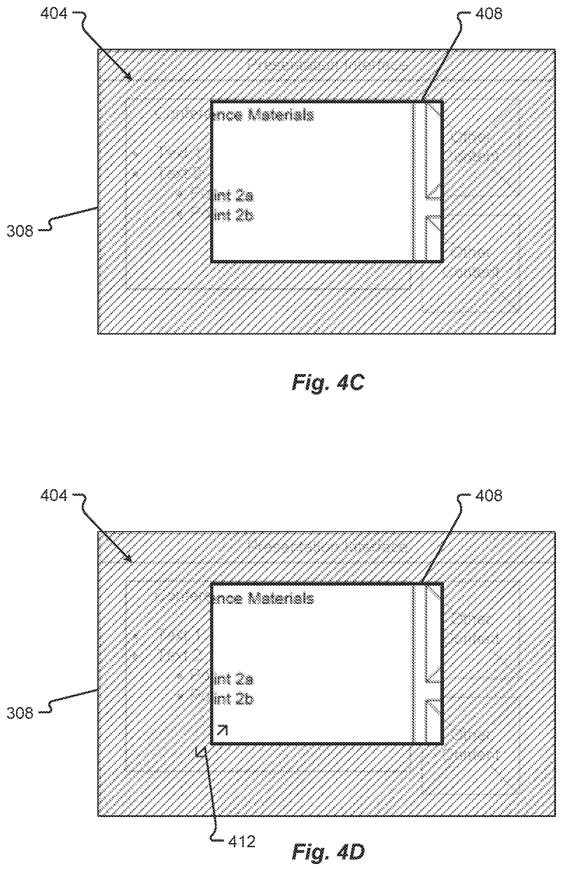

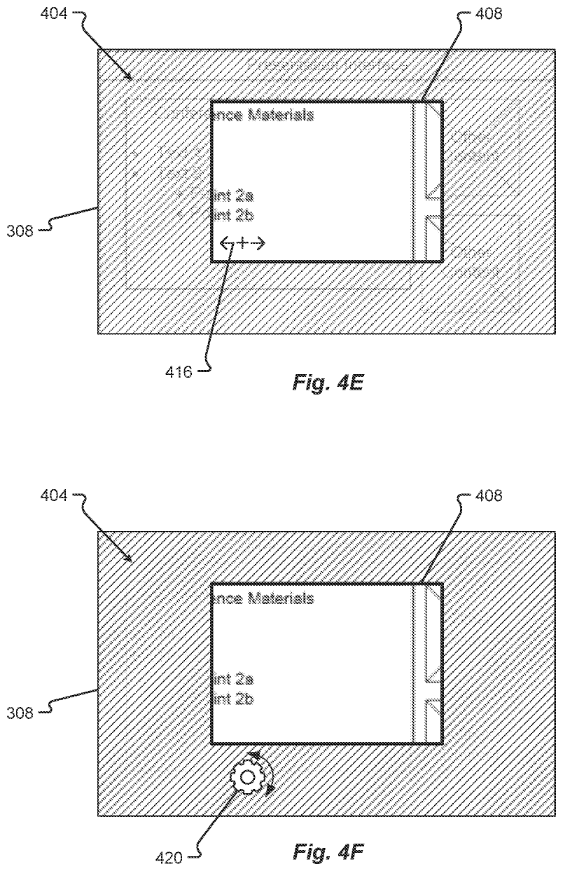

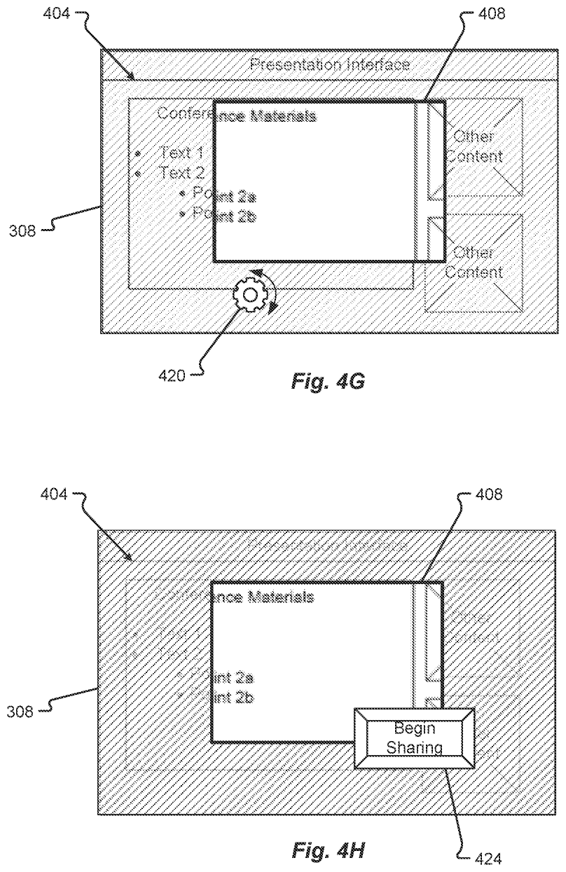

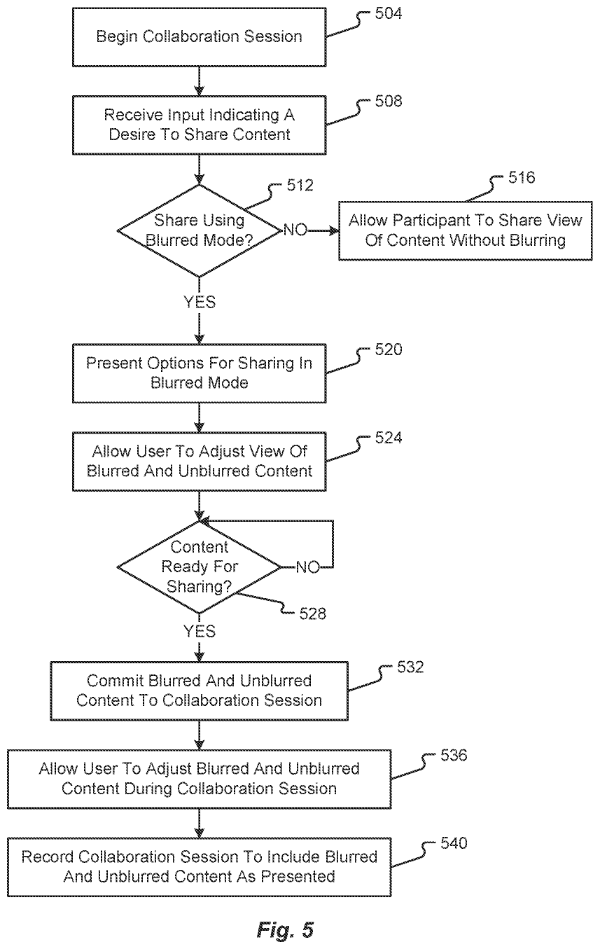

In some embodiments, operations and capabilities provided by the user interface 300 may be controlled by the image rendering instructions 212. In some embodiments, a presenting user may be allowed to share content (e.g., content from the display of the presenter communication device 108) with other participant communication devices 108 and/or a moderator communication device 124. If the moderator is the presenting user, then the moderator communication device 124 and presenter communication device 128 may be considered the same device. In some embodiments, a presenting user may be allowed to share content in a blurred mode. Details of sharing content with assistance of a blurred sharing mode will now be described with references to FIGS. 4A-7.

Referring initially to FIGS. 4A-4H and 5, a first collaboration method will be described in accordance with at least some embodiments of the present disclosure. The method is initiated when a collaborative communication session (e.g., a collaboration session) is initiated between two or more participants (step 504). During the collaborative communication session, one of the participants may desire to share content of their screen (e.g., enable screen sharing) with other participants of the collaborative communication session. The participant that desires to share content of their screen may be referred to hereinafter as a presenting user or sharing user.

The method may continue when the presenting user provides an indication to the collaboration service 116 that content is to be shared or presented from their user interface 300 with other participants in the collaborative communication session (step 508). Upon receiving the input from the presenting user, the collaboration service 116 may invoke the image rendering instructions 212, which may provide the presenting user with sharing options. One of the options that may be provided to the presenting user is an option to share a portion of their screen or an entirety of their screen. For example, the presenting user may be provided with an option to share a particular portion of their user interface 300, a particular window 304 of their user interface 300, a particular application being executed in parallel with the collaboration service 116, or the like. Alternatively or additionally, the presenting user may be provided with an option to draw a box or shape on their user interface 300 with their pointer to define an area of the user interface 300 to share or present to other participants. Alternatively or additionally, the presenting user may be provided with an option to share using a blurred mode (step 512).

Prior to the presenting user being provided with an option to share using a blurred mode, the user interface 300 of the presenting user may be unmodified or otherwise similar in appearance to the way the user interface 300 was displayed before receiving the input at step 508. If the presenting user denies the option to share in the blurred mode, then the presenting user may share some or all of their user interface 300 in a normal fashion (e.g., as shown in FIG. 4A) and any portion that is selected to be shared may be shared in its entirety, without blurring or any other obfuscation treatment (step 516).

If, however, the presenting user selects the option to share content in a blurred mode, then the method may continue with the image rendering instructions 212 and/or image obfuscation instructions 216 providing the presenting user with additional options for sharing in a blurred mode (step 520). The options may be provided to the presenting user via a collaboration tool or some other sharing tool that enables the presenting user to control and manipulate which portion(s) of their user interface 300 will be blurred and which portion(s) of their user interface 300 will not be blurred. Before the presenting user differentiates between blurred and unblurred portions of the user interface 300, the collaboration server 116 may initially show the presenting user what their shared content will look like if an entirety of the content is blurred.

FIG. 4B illustrates an example where the presenting user has elected to share their presentation interface area 308 with blurring 404, but before the presenting user has defined which portion(s) of the presentation interface area 308 should be unblurred or presented in the clear. As a default, the image rendering instructions 212 may assume that the presenting user does not want to share any content in the clear and so initially provides the presenting user with options for unblurring content that is otherwise entirely blurred 404. It should be appreciated, however, that the opposite approach may be taken where all content is initially unblurred and the presenting user is allowed to select which portions of the user interface 300 should be blurred 404 prior to sharing with other participants.

Continuing the above example, the presenting user may be allowed to create a view window 408 that bounds an area to be unblurred (e.g., as shown in FIG. 4C). The presenting user may also be provided with other options to control content sharing in the blurred mode. Other such options may include size controls 412 which provide options to change a size of the window 408 (e.g., as shown in FIG. 4D), position controls 416 to change a position or location of the window 408 (e.g., as shown in FIG. 4E), blur amount controls 420 to adjust an amount or degree of blurring applied to the blurred area 404 (e.g., as shown in FIG. 4F where blurring is increased and FIG. 4G where blurring is decreased), combinations thereof, and the like. In some examples, the presenting user may be allowed to create a plurality of different windows 408 (which may or may not overlap with another window 408) and each window 408 may be sized, positioned, etc. The options for sharing in the blurred mode may be provided to the presenting user prior to the presenting user committing their content for sharing with other participants in the collaborative communication session. Alternatively or additionally, one or more options for sharing in the blurred mode may be provided to the presenting user while the presenting user is sharing content in a blurred mode, in which case adjustments made by the presenting user may be immediately shown to other participants. These options may allow the presenting user to adjust a view of the blurred 404 and/or unblurred content (step 524).

While the window 408 is depicted as a tool to define and control an unblurred portion of the user interface 300, it should be appreciated that a window 408 may alternatively be configured to provide a tool that defines and controls a blurred portion of the user interface 300. Moreover, while only a single window 408 is depicted for ease of discussion, it should be appreciated that a presenting user may define a plurality of windows 408. All of the plurality of windows 408 may be used to define and/or control an unblurred portion of the user interface 300, all of the plurality of windows 408 may be used to define and/or control a blurred 404 portion of the user interface 300, some of the plurality of windows 408 may be used to define and/or control a blurred 404 portion whereas others of the plurality of windows 408 may be used to define and/or control an unblurred portion, etc. Each window 408 in the plurality of windows 408 may be of various sizes, may overlap, may be restricted from overlapping, and/or may be independently adjustable. In embodiments where two or more windows 408 are used to define a blurred 404 portion, each of the two or more windows 408 may have a different level of blurring applied thereto. For instance, a first window 408 may have a 50% blurring applied while a second window 408 may have a 25% blurring applied while a third window 408 may have a 90% blurring applied—again, each window 408 may be independently adjustable in terms of size, position, and/or degree of blurring.

As mentioned above, some embodiments contemplate allowing the presenting user to adjust views of the blurred and unblurred content in real-time such that participants can see each change applied by the presenting user. In other embodiments, the presenting user may be provided with an ability to preview content before it is shared with participants. In such a scenario, the method may require the presenting user to affirmatively indicate that the content is ready for sharing (step 528). As an example and as shown in FIG. 4H, the presenting user may be provided with a “begin sharing” option 424 or some other GUI input that, when selected by the presenting user, causes the preview content only being shown to the presenting user to be shared with other participants.

When the presenting user indicates that the content is ready for sharing, the method continues by committing the blurred 404 and unblurred content to the collaborative communication session (step 532). The blurred 404 and unblurred content may be rendered and shared by execution of the rendering instructions 212, possibly with assistance of the image obfuscation instructions 216. Once the presenting user is sharing content in a blurred mode, the presenting user may be allowed to adjust the blurred 404 and/or unblurred portions of the user interface 300 during the collaborative communication session (step 536). Changes made during the collaboration communication session may be shared with other participants immediately upon the presenting user making the change or such changes may undergo another process whereby the presenting user is asked if the changes should be shared before committing the changes to the collaborative communication session. Allowing the presenting user to make changes during the collaborative communication session may facilitate highlighting certain portions of the presented content, hiding sensitive content that was initially shared inadvertently, etc.

In some embodiments, the method may further include recording some or all of the collaborative communication session (step 540). The recording of the collaborative communication session, including image or display content that was shared during the collaborative communication session, may be stored in memory of the conference recording server 132 and/or as part of collaboration data 120. In some embodiments, the recording may reflect the blurred 404 and unblurred portions of the user interface 500 that was shared by the presenting user during the collaborative communication session.

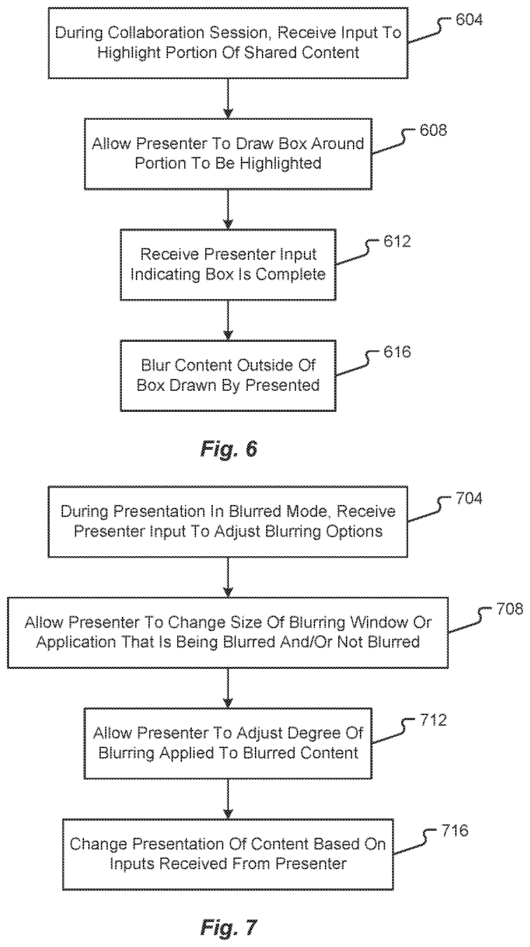

With reference now to FIG. 6, another collaboration method will be described in accordance with at least some embodiments of the present disclosure. The method is initiated during a collaborative communication session when a presenting user provides input to the collaboration service 116 indicating a desire to highlight a portion of shared content (step 604). The presenting using may then be provided with a collaboration tool option to highlight a portion of the shared content. As an example, the presenting user may be allowed to draw a box or other window 408 around some portion of their user interface 300 (e.g., bounding an area of shared presentation content) (step 608).

As discussed above, the presenting user may be allowed to adjust the size of the box or window 408 drawn. The method may continue when the presenting user provides an input that indicates the box or window 408 is complete (step 612). Upon receiving this input from the presenting user, the method continues by blurring 404 content outside of the box or window 408 drawn by the presenting user while keeping content inside of the box or window 408 unblurred (step 616). This type of collaboration method may allow a presenting user to quickly and easily highlight portions of shared content, thereby drawing other participant's attention to the unblurred content. Meanwhile, the irrelevant or unhighlighted portions of the presenting user's display may be obfuscated (e.g., lightly blurred 404), thereby rendering those unhighlighted portions difficult to view. Advantageously, this highlighting can be facilitated without requiring a resizing or re-rendering of the shared content, which can be distracting and frustrating to participants of the collaborative communication session.

With reference now to FIG. 7, another collaboration method will be described in accordance with at least some embodiments. The method begins during a collaborative communication session when a presenting user provides an input indicating a desire to adjust blurring options (step 704). The input may be provided to the collaboration service 116 and/or image rendering instructions 212 by way of a blurring tool that is made available to the presenting user.

The method continues by allowing the presenting user to change various aspects of the blurred and/or unblurred portions of content being shared with other participants. As an example, the presenting user may be allowed to change a size and/or position of a window 408 (step 708). As a more specific example, the presenting user may be provided with an option to blur or unblur an entire application window (e.g., to automatically cause a window 408 to align with a window of a particular application). The presenting user may also be allowed to adjust a degree of blurring applied to blurred 404 content (step 712). As an example, the presenting user may be provided with blur amount controls 420 that enable the presenting user to increase or decrease an amount or degree of blurring applied to blurred 404 content.

The method will continue with the image rendering instructions 212 and/or image obfuscation instructions 216 changing the presentation of the shared content according to the presenting user's blurring preferences (step 716). The steps of this method can be repeated as desired, possibly based on receiving further inputs from the presenting user. Alternatively, it may be possible to allow one user to act as the presenting user, who is responsible for controlling the overall content shared during the collaborative communication session. Meanwhile, a second user (i.e., a user other than the presenting user) may be allowed to adjust one or more aspects of the blurring applied to shared content. For example, a moderator may be allowed to control which slide or application is being shared during a collaborative communication session whereas a presenting user may be allowed to control the size, position, and/or degree of blurring applied to portions of the shared content. In other words, control of the blurring features does not necessarily need to reside with the same participant that is controlling other aspects of shared content. In this way, different participants may be allowed to highlight or draw attention to certain portions of the shared content even if those participants are not designated as the presenting user.

Any of the steps, functions, and operations discussed herein can be performed continuously and automatically. While the flowcharts have been discussed and illustrated in relation to a particular sequence of events, it should be appreciated that changes, additions, and omissions to this sequence can occur without materially affecting the operation of the disclosed embodiments, configuration, and aspects.

The illustrative systems and methods of this disclosure have been described in relation to conferences and communication systems. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-STM processors, other industry-equivalent processors, and may perform computational functions using any known or future-developed standard, instruction set, libraries, and/or architecture.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

1. A communication system, comprising:
a server, comprising:
a microprocessor; and
a computer readable medium coupled to the microprocessor and comprising instructions stored thereon that cause the microprocessor to:
receive an input indicating a desire to share image content among participants of a collaborative communication session;
provide a participant of the collaborative communication session with an in-collaboration control tool that enables the participant to adjust and control, during the collaborative communication session, blurring preferences in a blurred sharing mode;
receive, via the in-collaboration control tool, an input indicating a desire to share the image content using the blurred sharing mode and according to the blurring preferences of the participant, wherein the blurring preferences identify an application to blur in the blurred sharing mode;
automatically identify a first portion of the image content that will have blurring applied thereto when shared among the participants of the collaborative communication session, wherein the first portion of the image content corresponds to a window of the identified application;
identify a second portion of the image content that will not have blurring applied thereto when shared among the participants of the collaborative communication session; and
cause the image content to be shared among the participants of the collaborative communication session such that the first portion of the image content is blurred and the second portion of the image content is unblurred.

2. The communication system of claim 1, wherein the instructions further cause the microprocessor to:
identify a first participant of the collaborative communication session as a presenting user;
identify a second participant of the collaborative communication session as a non-presenting user; and
provide the first participant with access to the in-collaboration control tool that enables the first participant to adjust at least one of the first portion of the image content and the second portion of the image content.

3. The communication system of claim 2, wherein the instructions further cause the microprocessor to:
provide a preview of image content to the first participant, wherein the preview of the image content is not shared with the second participant;
receive, from the first participant, an input indicating a desire to share the image content with the second participant as shown in the preview of the image content; and
in response to receiving the input indicating the desire to share the image content with the second participant as shown in the preview of the image content, cause the image content to be shared among the participants of the collaborative communication session in accordance with the preview of the image content.

4. The communication system of claim 2, wherein the in-collaboration control tool provides the first participant with a control to change a size of at least one of the first portion and the second portion.

5. The communication system of claim 2, wherein the in-collaboration control tool provides the first participant with a control to change a position of at least one of the first portion and the second portion.

6. The communication system of claim 2, wherein the in-collaboration tool provides the first participant with a control to change a degree of blurring applied to the first portion.

7. The communication system of claim 2, wherein the in-collaboration control tool provides the first participant with an option to size at least one of the first portion and the second portion to coincide with an application window.

8. The communication system of claim 1, wherein the instructions further cause the microprocessor to:
identify a third portion of the image content that will have blurring applied thereto when shared among the participants of the collaborative communication session; and
cause the image content to be shared among the participants of the collaborative communication session such that the first portion of the image content and the third portion of the image content are blurred and the second portion of the image content is unblurred.

9. The communication system of claim 8, wherein the first portion of the image content has a different degree of blurring applied thereto as compared to the third portion of the image content.

10. A method, comprising:
receiving an input indicating a desire to share image content among participants of a collaborative communication session;
provide a participant of the collaborative communication session with an in-collaboration control tool that enables the participant to adjust and control, during the collaborative communication session, blurring preferences in a blurred sharing mode;
receive, via the in-collaboration control tool, an input indicating a desire to share the image content using the blurred sharing mode and according to the blurring preferences of the participant, wherein the blurring preferences identify an application to blur in the blurred sharing mode;
automatically identifying a first portion of the image content that will have blurring applied thereto when shared among the participants of the collaborative communication session, wherein the first portion of the image content corresponds to a window of the identified application;
identifying a second portion of the image content that will not have blurring applied thereto when shared among the participants of the collaborative communication session; and
sharing the image content with the participants of the collaborative communication session such that the first portion of the image content is blurred and the second portion of the image content is unblurred.

11. The method of claim 10, further comprising:
recording the image content shared with the participants of the collaborative communication session, wherein the recorded image content comprises the first portion of the image content with a blurred presentation and wherein the recorded image content comprises the second portion of the image content with an unblurred presentation.

12. The method of claim 10, further comprising:
identifying a first participant of the collaborative communication session as a presenting user;
identifying a second participant of the collaborative communication session as a non-presenting user; and
providing the first participant with access to the in-collaboration control tool that enables the first participant to adjust at least one of the first portion of the image content and the second portion of the image content.

13. The method of claim 12, wherein the first participant corresponds to a moderator of the collaborative communication session.

14. The method of claim 12, wherein the second participant defines the image content shared with the participants of the collaborative communication session and wherein the first participant interacts with the in-collaboration control tool that enables the first participant to adjust at least one of the first portion of the image content and the second portion of the image content.

15. The method of claim 12, wherein the in-collaboration control tool provides the first participant with a control to change a size of at least one of the first portion and the second portion.

16. The method of claim 12, wherein the in-collaboration control tool provides the first participant with a control to change a position of at least one of the first portion and the second portion.

17. The method of claim 12, wherein the in-collaboration control tool provides the first participant with a control to change a degree of blurring applied to the first portion.

18. A server, comprising:
a processor; and
a computer-readable medium, coupled with the processor, the computer-readable medium comprising instructions that are executable by the processor, wherein the instructions include:
instructions that enable a first participant to engage in a collaborative communication session with a second participant;
instructions that provide the first participant with an in-collaboration control tool that enables the first participant to adjust and control, during the collaborative communication session, blurring preferences in a blurred sharing mode, wherein the blurring preferences identify an application to blur in the blurred sharing mode;
instructions that provide the first participant with an ability to share image content with the second participant using the blurred sharing mode and according to the blurring preferences of the first participant defined via the in-collaboration control tool; and
instructions that share at least some of the image content with the second participant based on the blurring preferences defined by the first participant within the in-collaboration control tool, wherein an application window of the application is automatically blurred according to the blurring preferences.

19. The server of claim 18, wherein the in-collaboration control tool allows the first participant to define a degree of blurring to apply.

20. The server of claim 18, wherein the instructions further include instructions that record the image content shared with the second participant such that the recorded image content includes the blurring preference defined by the first participant.
